(19) United States
(12) Patent Application Publication
(10) Pub. No.: US 2020/0294021 A1
(43) Pub. Date: Sep. 17, 2020

(54) CONTENT ACCESS FOR TRANSACTION PROCESSING SYSTEM

(71) Applicant: Visa International Service Association, San Francisco, CA (US)

(72) Inventors: Gautam POORNACHANDRA, Austin, TX (US); Mahesh Kasarapu, Austin, TX (US); Bhavani Vishnu Kalathur, Austin, TX (US); Rama Krishna Kantipudi, Austin, TX (US); Srinivas Vennam, Cedar Park, TX (US)

(21) Appl. No.: 16/355,324

(22) Filed: Mar. 15, 2019

(51) Int. Cl. G06Q 20/20; G06K 19/06; G06K 7/14; G06F 16/955

(52) U.S. Cl. CPC G06Q 20/208; G06F 16/9554; G06K 7/1417; G06K 19/06037

(57) ABSTRACT

Described herein are systems and techniques for enabling a resource provider to generate and provide transaction-related content to a user device with respect to a transaction. In some embodiments, the system described herein involves the generation of one or more machine-readable codes which include item information to be used in conducting a transaction. In some embodiments, the system may assign a memory location to the transaction, either locally or remotely. A link to the memory location may be included within a machine-readable code. Upon receiving an indication that the transaction has been completed, the system is configured to generate and provide transaction-related content to the user device in a manner that maintains anonymity for the user device.

### BACKGROUND

Transaction processing systems are typically delineated into either “push” or “pull” processing models. Historically, a majority of transaction processing systems have been pull systems, in which a transaction is processed by a resource provider and funds are pulled from an authorization entity. However, push transaction processing systems have gained popularity in recent years because of the advantages that they provide over conventional transaction processing systems. In a push transaction processing system, a transaction is initiated by a user device (e.g., a consumer) and funds are pushed to the resource provider of the transaction by the authorization entity. These types of transactions are advantageous because a number of transactions can occur out of order (as they are approved) or all at the same time (i.e., consumers need not wait in line). Additionally, consumers can remain completely anonymous to the resource provider. For example, the resource provider need never be given payment device information or other consumer details.

However, resource providers are often unable to provide transaction content for push transactions, as consumers may be anonymous, which can be problematic. For example, some consumers may wish to perform charitable giving while taking advantage of the anonymity offered by a push transaction system. In this example, the consumer may, rightfully, be concerned that making a donation will subject him or her to future solicitation by the recipient. By way of illustration, donating to a charitable organization will often make the donor a target for future fundraising drives. Although the consumer may be able to donate to the charity anonymously, doing so would be less desirable if the consumer would then be unable to take advantage of any tax benefits that could be derived from the transaction.

Embodiments of the disclosure address these and other problems, individually and collectively.

### SUMMARY

Described herein are a system and techniques for enabling a resource provider to generate and provide transaction-related content to a user device with respect to a transaction. In some embodiments, the system described herein involves the generation of a machine-readable code which includes item information to be used in conducting a transaction. In some embodiments, the system may assign a memory location to the transaction, either locally or remotely. The transaction may be conducted as a push transaction via a user device. Upon receiving an indication that the transaction has been completed, the system is configured to generate and provide transaction-related content to the user device in a manner that maintains anonymity for the user device. In some embodiments, this may involve the generation of a second machine-readable code. In some embodiments, this may involve uploading transaction-related content to a memory location, from which it may be accessed by the user device.

These and other embodiments of the disclosure are described in further detail below.

### BRIEF DESCRIPTION OF THE DRAWINGS

FIG. 1 depicts an overview of interactions between various components of a system in accordance with at least some embodiments;

FIG. 2 depicts a diagram of an exemplary resource provider computer that may be configured to conduct push transactions in accordance with at least some embodiments;

FIG. 3 depicts a block diagram illustrating an example process for providing transaction-related content to a user device in accordance with at least some embodiments;

FIG. 4 depicts a block diagram illustrating a first process for conducting a transaction using the system described herein in accordance with at least some embodiments;

FIG. 5 depicts a block diagram illustrating a second process for conducting a transaction using the system described herein in accordance with at least some embodiments;

FIG. 6 depicts a flow chart illustrating a process for a resource provider to provide transaction-related content to a user device upon completion of a transaction in accordance with at least some embodiments;

FIG. 7 depicts an illustrative example of a first interaction that may occur in accordance with some embodiments of the disclosure;

FIG. 8 depicts an illustrative example of a second interaction that may occur in accordance with some embodiments of the disclosure; and

FIG. 9 depicts a flow diagram illustrating an example process for providing transaction-related content to a user device in accordance with at least some embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Prior to discussing the details of some embodiments of the present disclosure, description of some terms may be helpful in understanding the various embodiments.

An “access device” may be any suitable device that provides access to a remote system. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user mobile device.

An “application” may refer to any set of computer-executable instructions configured to cause a processor to execute a function or access a resource. An application may be installed on, and executed from, a client device. Applications may be installed on a client device by a manufacturer of the client device or by another entity. An application installed on a mobile client device may be referred to as a mobile application.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization.

An “authorization server” may be any computing device operated by an entity that authorizes a request. Examples of such an entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the user.

The term “content” or “transaction-related content” may refer to a document or other suitable electronic message related to a product and/or transaction. In some embodiments, content may refer to warranty documentation, return instructions, a title or deed, a user manual, digital media, or any other suitable documentation.

An “electronic catalog” may include any collection of resource information. In some embodiments, an electronic catalog may be maintained by a resource provider, and may comprise a number of entries in a database. Each entry in an electronic catalog may pertain to a different resource (e.g., a good or service) or group of resources managed by the resource provider.

A “machine-readable code” may include any images or symbols that can be read through an electronic device for interpretation and manipulation by a computer. Some examples of machine-readable codes include barcodes, quick response (QR) codes, Military Spec UID codes, and any other suitable code.

A “resource provider” may be an entity that can provide a resource such as goods, services, information, and/or access. Examples of a resource provider include merchants, access devices, secure data access points, etc. A “merchant” may typically be an entity that engages in transactions and can sell goods or services, or provide access to goods or services.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “transaction” may be any interaction or exchange between two or more parties. For example, a transaction may include a first entity requesting resources from a second entity. In this example, the transaction is completed when the resources are either provided to the first entity or the transaction is declined.

Details of some embodiments of the present disclosure will now be described in greater detail.

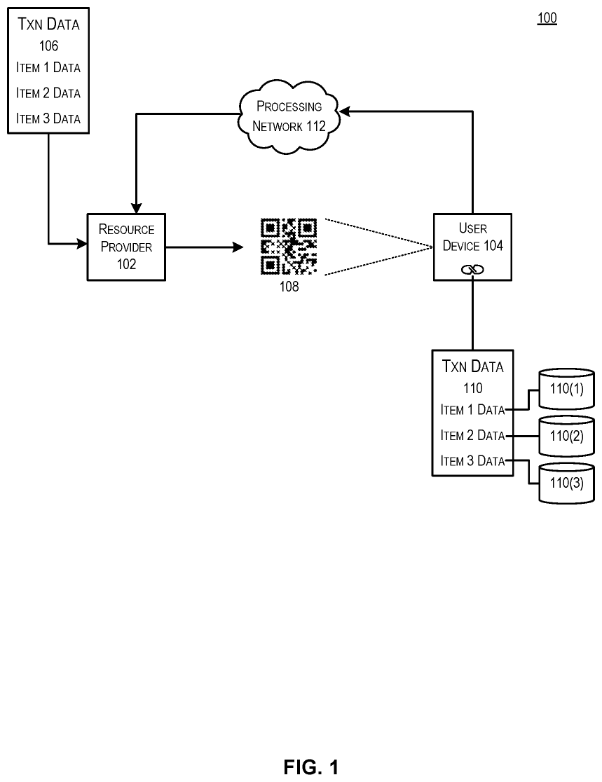

FIG. 1 depicts an overview of interactions between various components of a system in accordance with at least some embodiments. In the system 100, a resource provider 102 may manage access to one or more resources. A user wishing to obtain access to the resources managed by the resource provider 102 may use a user device 104 to interact with the resource provider 102. In particular, the resource provider 102 may compile transaction data 106 into a machine-readable code 108, which may then be scanned using the user device 104 in order to obtain transaction data 110. The system may include a transaction processing network 112 configured to process push transactions in accordance with embodiments described herein.

Resource provider 102 may include any computing device configured to manage access to one or more resources (e.g., a merchant point-of-sale or other suitable access device). In some embodiments, the resource provider 102 may be a merchant that operates a physical retail location. In some embodiments, the resource provider 102 may be a merchant that maintains an online presence (e.g., an electronic retailer). The resource provider 102 may be configured to process transactions a push transaction processing system and/or a pull transaction processing system. In some embodiments, the resource provider 102 may be configured to generate a machine-readable code 108 from transaction data 106 that may be used by a user device 104 to complete a push transaction. In some embodiments, the resource provider 102 may also be configured to generate a machine-readable code that may include content associated with the transaction.

In some embodiments, the transaction data 106 may include any suitable information related to one or more items in a transaction. In some embodiments, the transaction data 106 may include a transaction identifier that may be used to identify a particular transaction. In some embodiments, transaction data 106 may be maintained on a computing device which is separate from the resource provider (i.e., a host server). For example, in some embodiments, the machine-readable code 108 generated by the resource provider 102 may include a link which represents a reference to a location in memory at which at least a portion of transaction data 106 is stored.

The user device 104 may be any suitable device capable of being used to conduct a transaction in accordance with embodiments of the system described herein. In some embodiments, the user device 104 may be a mobile phone or other suitable device. In some embodiments, the functionality described herein with respect to the user device 104 may be performed via a set of computer executable instructions installed upon, and executed by, the user device 104. A mobile application is an example of a set of computer executable instructions that may be implemented.

In some embodiments, the resource provider 102 may be configured to generate two separate machine-readable codes 108 to be read by the user device 104. For example, the resource provider 102 may generate a first machine-readable code 108 that includes details of a transaction to be conducted. The user device 104 may use the details of the transaction to complete the transaction (e.g., via a push transaction processing system). Upon receiving an indication from the processing network 112 that the transaction has been completed, the resource provider 102 may generate a second machine-readable code 108 which includes the transaction data 110 to be provided to the user device 104. In at least some of these embodiments, the resource provider 102 may be configured to replace the first generated machine-readable code 108 with the second generated machine-readable code as quickly as possible. For example, the user device 104 may be configured to conduct the transaction as soon as it obtains the information in the first generated machine-readable code. The processing network 112 may process the transaction within a short span of time and provide the approval (or denial) to the resource provider 102. The resource provider may then automatically generate and display the second machine-readable code to the user device. The result of this is that the user may position the user device 104 to scan the machine-readable code 108 and the user device 104 may scan both machine-readable codes before the user device 104 is removed from its position. In this manner, the transaction data 110 may be provided to the user device 104.

In some embodiments, the resource provider 102 may be configured to generate a machine-readable code 108 which includes transaction data 110 that may be dynamically updated. For example, the resource provider 102 may reserve a location in memory at which transaction data 110 may be placed. The resource provider 102 may then generate a link (i.e., a reference to the location in memory) to be included in the machine-readable code 108. In these embodiments, once the resource provider has determined that the transaction has been completed, it may generate transaction data 110 and may store that transaction data 110 in the reserved memory location. This enables the user device 104 to access the transaction data 110 without further interaction with the resource provider 102.

In some embodiments, the transaction data 110 may include any suitable information related to one or more items in the transaction. For example, transaction data 110 may include a receipt for the transaction. In another example, transaction data 110 may include a user manual or warranty information for an item or items. In yet another example, transaction data 110 may include digital content (e.g., bonus content) to be provided as a reward for completing a purchase with the resource provider. In some embodiments, the transaction data 110 may be included as text within the machine-readable code 108. In some embodiments, the machine readable code 108 may include one or more links which reference a location at which transaction data 110 is stored. In some embodiments, a link may be transaction-specific (e.g., associated with a particular transaction). In some embodiments, the same link may be shared in a number of transactions. For example, any user that purchases a particular item may be given the same link, which references a location at which a user manual for the item is stored. In some embodiments, the user device 104 may be provided with multiple links for a single transaction. For example, upon completing a purchase for item 1, item 2, and item 3, the user device 104 may be provided with a machine-readable code 108 that includes links to transaction data 110(1), 110(2), and 110(3) respectively, which correlate to each of the items purchased.

In some embodiments, the transaction data 110 may be dynamic in that it is stored at a link that may be updated at a later date/time. For example, the resource provider 102 may provide a link to the user device 104 via a machine readable code 108 along with details needed to complete the transaction. In this example, upon completion of the transaction, the resource provider 102 may generate a receipt for the transaction and may store that receipt at a memory location to which the link refers. In this example, the user device 104 may access the receipt after completing the transaction while maintaining its anonymity.

By way of illustrating interactions between the various components as described above, consider the following simplified example scenario. In this scenario, a user may select a number of items for a purchase transaction. The user may approach an access device associated with the resource provider (e.g., a register) to complete the purchase transaction. Information related to each of the items may be compiled into transaction data, which may then be used (e.g., by a resource provider associated with the access device) to generate a machine-readable code. In some cases, this may involve generating a message that includes information related to each of the items and including that message in the machine-readable code. In some embodiments, this may involve generating a message that includes information related to one or more of the items and including a link to that message within a machine-readable code. The user device 104 is then able to obtain transaction data for the transaction from the machine-readable code.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the internet), using any suitable communication protocol.

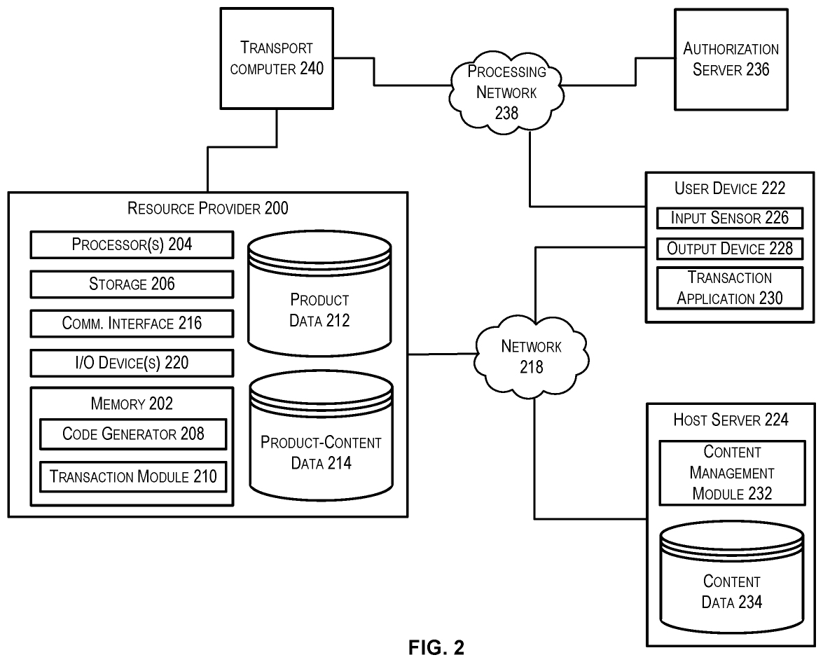

FIG. 2 depicts a diagram of an exemplary resource provider computer 200 that may be configured to conduct push transactions in accordance with at least some embodiments. The resource provider computer 200 may be an example resource provider computer 102 described with respect to FIG. 1.

The resource provider computer 200 may be any type of computing device capable of generating a machine-readable code capable of being used to conduct a transaction. In at least some embodiments, the resource provider computer 200 may include at least one memory 202 and one or more processing units (or processor(s)) 204. The processor(s) 204 may be implemented as appropriate in hardware, computer-executable instructions, firmware or combinations thereof. Computer-executable instruction or firmware embodiments of the processor(s) 204 may include computer-executable or machine executable instructions written in any suitable programming language to perform the various functions described.

The memory 202 may store program instructions that are loadable and executable on the processor(s) 204, as well as data generated during the execution of these programs. Depending on the configuration and type of resource provider computer 200, the memory 202 may be volatile (such as random access memory (RAM)) and/or non-volatile (such as read-only memory (ROM), flash memory, etc.). The resource provider computer 200 may also include additional storage 206, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the resource provider computer 200. In some embodiments, the memory 202 may include multiple different types of memory, such as static random access memory (SRAM), dynamic random access memory (DRAM) or ROM.

Turning to the contents of the memory 202 in more detail, the memory 202 may include an operating system and one or more application programs or services for implementing the features disclosed herein including at least a module for generating a machine-readable code to be used to complete a transaction (code generator 208), and a module for updating a status of a transaction (transaction module 210). The memory 202 may also include a number of data stores, including product data 212, which maintains information associated with various products, and/or product-content data 214, which may include information about content associated with products and/or transactions.

In some embodiments, the code generator 208 may, in conjunction with the processor 204, be configured to generate a machine-readable code to be used in conducting a transaction. In some embodiments, the code generator 208 may receive an indication of content to be provided in the machine-readable code from the transaction module 210. The machine-readable code may be generated to include a link or other reference to a memory location at which content related to the transaction is currently, or will be, stored.

In some embodiments, the transaction module 210 may, in conjunction with the processor 204, be configured to receive an indication of one or more items for which a transaction is to be generated. The transaction module 210 may, upon identifying the one or more items, generate a transaction identifier to be associated with the transaction. The transaction module 210 may identify content to be provided to a transactor based on the one or more items. For example, the transaction module 210 may identify warranty information, user manuals, bonus content, or any other suitable information related to particular items and/or a transaction. In some embodiments, the transaction module 210 may generate, or otherwise obtain a link to a memory location at which content may be stored for the location. In some embodiments, the transaction module 210 may store a mapping between a transaction (e.g., via a transaction identifier) and a particular memory location.

In some embodiments, the transaction module 210 may be further configured to, upon receiving an indication that a transaction has been completed, update content stored in a memory location associated with that transaction. For example, the transaction module 210 may receive an indication that a particular transaction has been completed, generate a receipt for the transaction, and upload the receipt to the memory location associated with that transaction. This enables a user device 222 which has been provided with a link to the memory location associated with the transaction to access the uploaded content any time after the content has been uploaded.

In some embodiments, the transaction module 210 may be further configured to, upon receiving an indication that a transaction has been completed, cause the code generator 208 to generate a second machine-readable code that includes transaction-related content. For example, the transaction module 210 may cause the code generator 208 to generate a quick response (QR) code that includes a receipt for the transaction and may present that QR code to the user device 222. In some embodiments, the QR code may be presented to the user device 222 in a manner such that the second QR code is read by the user device 222 immediately after presentation of the first QR code and prior to the user device being removed from its position for reading the first QR code.

The data stored in databases 212 and/or 214 may be dynamic, static, or some combination of dynamic and static data. In some embodiments, product data 212 may include any information about products. For example, the product data 212 may include information about product attributes, a price for the product, a product category, user reviews, or any other suitable information related to the product. Information stored in product data 212 may be provided by a manufacturer of a product, a resource provider, a user (e.g., via customer feedback), or any other suitable entity. In some embodiments, product data 212 may be an electronic catalog. In some embodiments, product-content data 214 may include any information pertaining to suitable content related to a product and/or transaction. For example, the product-content data 214 may include an indication of one or more mappings between a product and content related to that product (e.g., a user manual, warranty, rebate, etc.). In a second example, the product-content data 214 may include a number of memory locations, each of which is assigned to a specific transaction, such that a receipt for that transaction may be stored in the memory location.

The resource provider computer 200 may also contain communications interface(s) 216 that enable the resource provider computer 200 to communicate with a stored database, another computing device or server, one or more remote devices, and/or any other suitable electronic devices. In some embodiments, the communication interface 216 may enable the resource provider computer 200 to communicate with other electronic devices on a network 218 (e.g., on a private network). The resource provider computer 200 may also include input/output (I/O) device(s) and/or ports 220, such as for enabling connection with a keyboard, a mouse, a pen, a voice input device, a touch input device, a display, speakers, a printer, etc.

The resource provider computer 200 may be in communication with a number of user devices 222 and/or host servers 224. Each of the user devices 222 may be capable of interacting with the resource provider 200 or host server 224 to conduct a transaction and/or access content stored at a memory location. For example, the user devices 222 may include a web browser or other application that enables a user of the user device 222 to access a website maintained by the resource provider 200 or host server 224. In some embodiments, the resource provider 200 may maintain an account with respect to one or more user devices 222.

The user device 222 may include one or more input sensors 226 capable of reading a machine-readable code (e.g., a barcode scanner). The user device 222 may also include one or more output devices 228 capable of presenting content to a user of the user device 222. For example, the output devices 228 may include one or more displays and/or speaker devices capable of playing visual or audio content. In some embodiments, the user device 222 may include a transaction application 230, which may be a set of computer executable instructions (e.g. an application) which, when executed, causes the user device 222 to interpret data included in a machine-readable code and to conduct a transaction using that data. In some embodiments, a transaction application 230 may be an application which is maintained on behalf of, and supported by, a particular authorization entity (e.g., an issuer). In some embodiments, a transaction application 230 may be further configured to access content at a memory location specified in a machine-readable code.

In some embodiments, a host server 224 may be any computing device capable of providing content (i.e., documentation) to a user device 222. In some embodiments, the host server 224 may include, in its memory, one or more modules for making content accessible to a user device 222 to be viewed (content management module 232). In some embodiments, the host server 224 may store content data 234, which may include transaction-related content. The host server 224 may provide access to content data 234 to a user device. In at least some embodiments, the host server 224 may provide a pointer or link, and in some cases a cryptographic key, to a resource provider 200 and/or user device 222 for particular content stored in the content data 234. In these embodiments, the user device 222 may be configured to access content via the provided pointer or link.

In some embodiments, the user device 222 may be in communication with an authorization server 236. For example, the transaction application 230 in memory of the user device 222 may be a payment application configured to communication with one or more authorization servers 236 via a processing network 238. In this example, the transaction application 230 may be configured to generate an authorization request message for a transaction and to provide the generated authorization request message to a processing network 238 to be routed to the appropriate authorization server 236.

In some embodiments, an authorization server 236 may be configured to approve or decline a transaction conducted via the user device 222. Upon approval of the transaction the authorization server 236 may be configured to provide an authorization response message to a transport computer 240 associated with the resource provider 200. In some embodiments, an appropriate transport computer 240 may be identified based on a merchant identifier included in the authorization request message. In some embodiments, the authorization response message may be provided to the user device 222.

With respect to the example architecture depicted in FIG. 2, various components may interact in a number of ways to enable the functionality described herein. In an exemplary interaction, a resource provider 200, upon receiving an indication of a transaction to be conducted, may generate a machine-readable code that includes information to be used in completing that transaction. In some embodiments, the machine-readable code may also include a link or other reference pointer at which content related to the transaction will be placed. The machine-readable code may be presented to a user device 222 via a display mechanism. For example, the machine-readable code may be displayed upon a display device in communication with resource provider 200.

Continuing with the above exemplary interaction, the user device 222 may scan the machine-readable code in order to interpret the information to be used in completing the transaction. In some embodiments, the user device 222 may also identify a link or other reference pointer to be associated with the transaction to be conducted within the machine-readable code. The user device 222, via the transaction application, may then initiate the requested transaction by generating a request to an authorization entity server.

Once the resource provider 200 has received notification from the authorization entity server that the transaction has been completed, the resource provider 200 may provide transaction-related content to the user device 222. In some embodiments, the resource provider 200 may generate a second machine-readable code that includes transaction-related content or a link to transaction-related content. In some embodiments, the resource provider 200 may store, or cause to be stored, transaction-related content to a memory location referenced by a link previously provided to the user device 222.

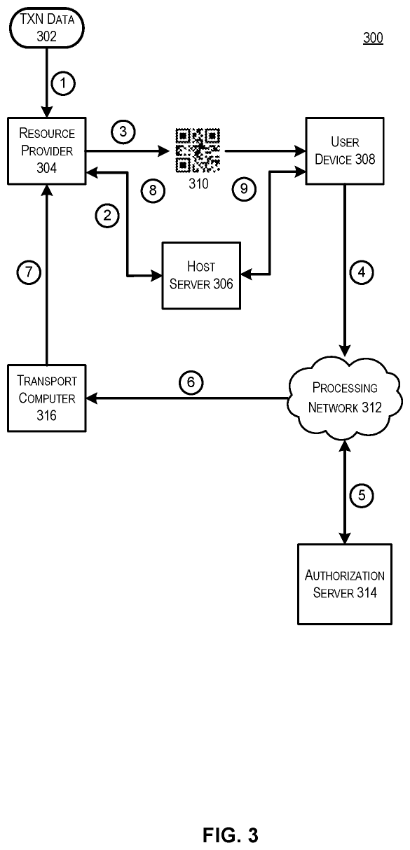

FIG. 3 depicts a block diagram illustrating an example process for providing transaction-related content to a user device in accordance with at least some embodiments. The process 300 is illustrated as a logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be omitted or combined in any order and/or in parallel to implement this process and any other processes described herein.

Process 300 may begin at step 1, when transaction data 302 is received at a resource provider 304 indicating a transaction to be conducted. Resource provider 304 may be an example of resource provider 200 described with respect to FIG. 2. In some embodiments, the transaction data 302 may include one or more item identifiers associated with resources to which access is to be obtained via the transaction. In some embodiments, the transaction data 302 may be received via an access device in communication with the resource provider 304. For example, a user may present one or more items to a point-of-sale (POS) terminal (an example of an access device) and information associated with those items may then be transmitted to the resource provider 304.

In some embodiments, the resource provider 304 may request a memory location to be associated with the transaction from a host server 306 at step 2. Host server 306 may be an example of host server 224 described with respect to FIG. 2. The host server 306 may be operated by the same entity as, or a different entity from, the resource provider 304. In some embodiments, the host server 306 may return a memory location which is associated with static content. For example, upon determining that the transaction includes a particular item, the resource provider 304 may request a reference to a memory location at which content associated with that item is stored. In this example, the host server 306 may respond by providing the same memory location for every transaction that involves the particular item.

In some embodiments, the host server 306 may return a memory location which is associated with dynamic content. For example, the host server 306 may identify a memory location which is currently empty and/or unassociated with a transaction. In these embodiments, a link to the memory location may return any content that happens to be stored at the memory location at the time that it is accessed. This enables the resource provider 304 to upload a receipt to the memory location at a later time, so that a user device 308 may be provided with a receipt after completion of the transaction but without further interaction with the resource provider 304.

It should be noted that in some embodiments, the resource provider 304 may determine that a memory location is not needed. For example, the resource provider 304 may determine that transaction-related content to be provided to a user device 308 contains a number of characters which is less than some threshold number of characters. By way of illustration, the resource provider 304 may determine that a receipt generated for a particular transaction includes 2000 characters. The resource provider 304, when determining whether to request a memory location, may compare the 2000 characters of the receipt against a maximum character threshold for a machine-readable code. Because a QR code can support a maximum of 4296 characters, the resource provider 304 may elect not to request a memory location for the receipt containing 2000 characters. In this scenario, the resource provider may generate a QR code that includes the entire receipt. However, in a second example in which the receipt includes 7000 characters, the resource provider 304 may elect to request a memory location. In some embodiments, the resource provider 304 may request a memory location to be included in the machine readable code regardless of the number of characters in transaction-related content.

At step 3 of process 300, the resource provider 304 may generate and present a machine-readable code 310 to a user device 308. The machine-readable code 310 may include any suitable information that can be used to complete the transaction. In some embodiments, the machine-readable code may include at least a transaction identifier, an amount of the transaction, and a merchant identifier. In some embodiments, the machine-readable code may include one or more links or references to memory locations.

Upon scanning the machine-readable code 310, the user device 308 may interpret the information within the machine-readable code 310 and generate a transaction request using that information. In some embodiments, this may be done via a mobile application installed upon, and executing on, the user device 308. The user device 308 may select an appropriate payment device to be used in completing the transaction. In some embodiments, the user device 308 may select a default payment device which is used to complete transactions conducted by the user device 308. For example, a payment device identifier may be entered into the user device 308 by a user during an enrollment (or update) period. In this example, the entered payment device identifier may be set as a default to be used in transactions unless otherwise indicated. In some embodiments, the user device 308 may request selection of a payment device by a user. For example, the user device may present a list of payment devices associated with the user to the user and may receive as input a selection of a particular payment device from the list of payment devices to be used in completing the transaction. The user device 308 may then generate a transaction request (e.g., an authorization request message) using the transaction information obtained from the machine-readable code 310 and the payment device.

In some embodiments, the user device 308 may identify one or more links within the information obtained via the machine-readable code 310. In some embodiments, the user device 308 may store the one or more links in association with the transaction for future reference (e.g., for use after completion of the transaction). In some embodiments, the user device 308 may be caused to access the one or more links prior to generating a transaction request. For example, the user device 308 may obtain content stored at the link and may present that content to the user to obtain approval prior to generating the transaction request. In this example, the content may include at least a portion of the transaction data 302, which would enable the user to ensure the accuracy of the transaction prior to approving it.

At step 4, the user device 308 may transmit the generated transaction request to a transaction processing network 312. The transaction processing network 312 may, in turn, determine an appropriate authorization server 314 associated with the payment device identified from the transaction request. For example, the transaction processing network 312 may determine an authorization server 314 associated with a banking identification number (BIN) or routing number included in the payment device identifier.

At step 5, the transaction processing network 312 may transmit the transaction request to the determined authorization server 314. The authorization server 314, upon receiving the transaction request, may determine whether to approve or decline the transaction associated with the transaction request. The authorization server 314 may then respond to the transaction request via an authorization response message. The authorization response message may be provided to the processing network 312.

At step 6, the transaction processing network 312 may identify the resource provider 304 associated with the transaction via a merchant identifier included in the transaction request/authorization response message. The transaction processing network 312 may subsequently route the authorization response message to a transport computer 316 determined to be associated with the identified resource provider. The transport computer 316, upon receiving the authorization response message, may provide a notification to the resource provider 304 that the transaction has been approved/completed at step 7.

Upon receiving an indication that the transaction has been approved, the resource provider 304 may generate transaction-related content (e.g., a receipt or other digital content) to be associated with the transaction. At step 8, the resource provider 304 may provide access to the transaction-related content to the user device 308. In some embodiments, the resource provider 304 may generate a second machine-readable code 310 that includes the transaction-related content. In these embodiments, the user device 308 may obtain the transaction-related content upon scanning the second machine-readable code 310. In some embodiments, the resource provider 304 may upload the generated transaction-related content to the memory location associated with the transaction. In some cases, a link to the memory location may have already been provided to the user device 308 via the machine readable code 310. In other cases, the resource provider 304 may generate a second machine-readable code 310 that includes a link to the memory location.

Subsequent to the generation of transaction-related content by the resource provider 304, the user device 308 may obtain the transaction-related content at step 9. In some embodiments, the user device 308 may obtain the transaction-related content from a second machine-readable code 310 generated by the resource provider 304. In some embodiments, the user device 308 may obtain the generated transaction-related content by accessing it at the memory location via a link obtained via a machine-readable code.

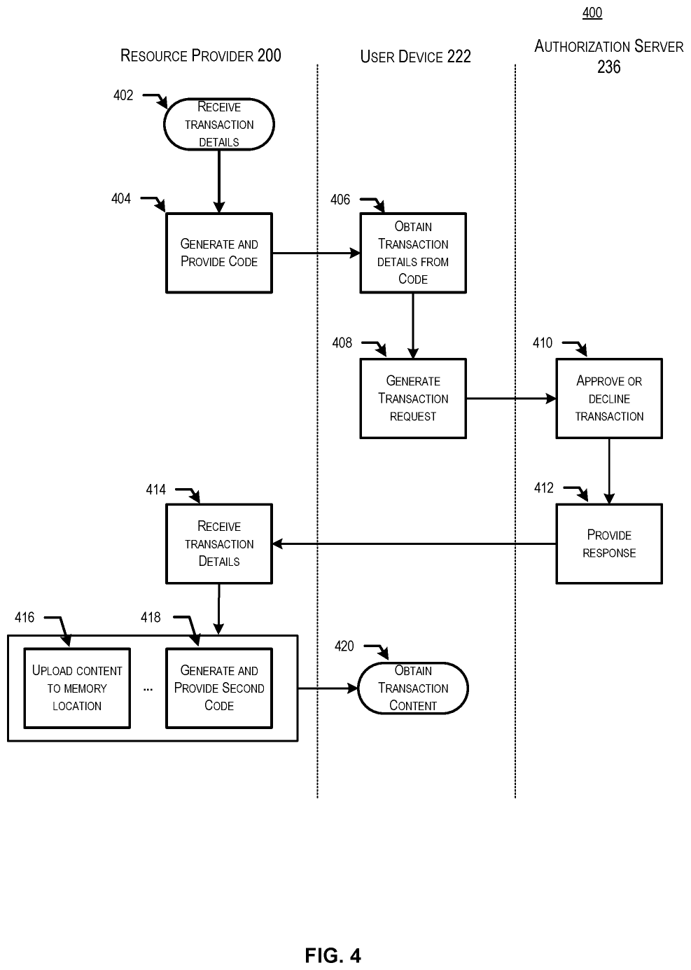

FIG. 4 depicts a block diagram illustrating a first process for conducting a transaction using the system described herein in accordance with at least some embodiments. The process 400 depicted in FIG. 4 focuses on interactions between a resource provider 200, a user device 222, and an authorization server 236 as described with respect to FIG. 2.

In process 400, a resource provider 200 may receive transaction details at 402 associated with a transaction to be completed. In some embodiments, this may involve information obtained regarding selection of one or more items by a user of a user device 222 (e.g., presentation of the one or more items to a POS). In some embodiments, the resource provider 200 may identify a particular product or item to be associated with a transaction independent of any selection by a user. In some embodiments, transaction details may include a serial number, or other unique identifier, associated with a particular item.

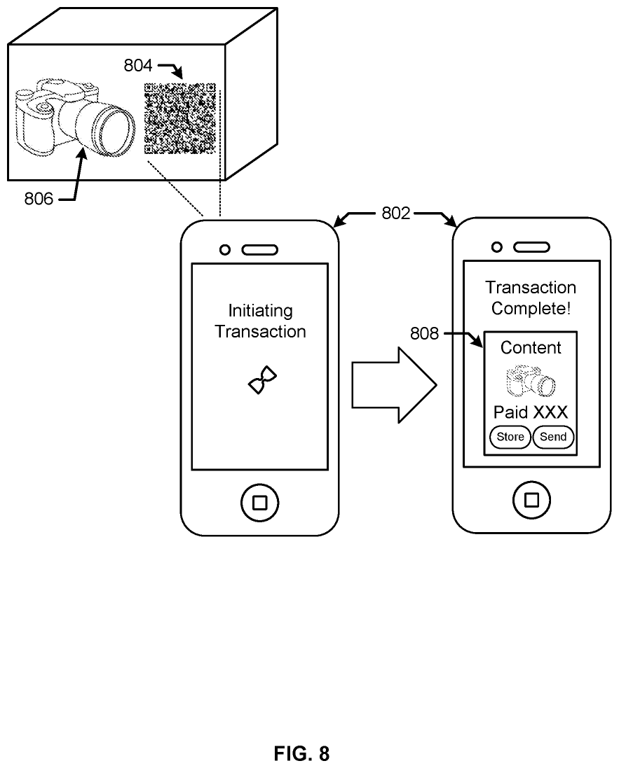

At 404, the resource provider 200 may generate a machine-readable code to be associated with a potential transaction. The machine-readable code may be any suitable means of conveying a message that can be interpreted using electronic means (e.g., a barcode or quick response (QR) code). In some embodiments, the resource provider 200 may create a QR code or product code for each of one or more products that it offers. In at least some of these embodiments, the QR code may include a link to a memory location which is specific to that product or product type. This will be described in greater detail below with respect to FIG. 8.

At 406, the transaction details may be obtained by a user device 222 upon scanning the machine-readable code. In some embodiments, scanning the machine-readable code may cause a transaction application installed on the user device 222 to be activated. For example, the machine-readable code may include instructions to execute the transaction application. In another example, the machine-readable code may include a specific format associated with the transaction application such that the transaction application is caused to be executed in order to interpret the machine-readable code. The transaction details included in the machine-readable code may include any details relevant to a transaction to be completed. In some embodiments, the transaction details may include a link to a memory location.

At 408, the user device 222, via a transaction application installed upon the user device 222, may generate a transaction request using the obtained transaction details and a payment device identifier. For example, the user device 222 may generate an authorization request message for a transaction based on the transaction details provided along with a default or selected payment device identifier. In some embodiments, the transaction request may be generated automatically (e.g., without further user interaction) upon obtaining the transaction details from the machine-readable code. In some embodiments, the user device 222 may request input from the user prior to generating the transaction request. For example, the user device may request authorization to proceed with the transaction or may request selection of a particular payment device from a set of payment devices. In some embodiments, at least a portion of the obtained transaction details may be presented to the user.

At 410, the user device 222 may initiate the transaction by transmitting the generated transaction request to an authorization server 236 associated with the payment device. This may be done by providing the transaction request to a transaction processing network, which may route the transaction request to the appropriate authorization server 236. The authorization server 236 may, upon receiving the transaction request, determine whether to approve or decline the requested transaction. In some embodiments, the determination may be made based on an account balance associated with the payment device. In some embodiments, the authorization server 236 may determine a level of risk associated with the transaction based on one or more factors associated with the transaction and may approve or decline the transaction based on whether the determined level of risk exceeds some threshold risk value. Upon determining whether to approve or decline the transaction, the authorization server 236 may provide an authorization response message at 412.

At 414, the resource provider 200 may receive an indication that the transaction has been approved. In some embodiments, the resource provider 200 may receive an authorization response message from the authorization server 236. Upon receiving the indication, the resource provider 200 may update a status of the transaction to reflect that the transaction has been completed. In some embodiments, the resource provider 200 may generate a transaction receipt or other suitable content. In some embodiments, the resource provider may identify and/or generate one or more content to be associated with the transaction (e.g., content associated with an item, etc.). The resource provider 200 may then provide the transaction-related content to the user device. It is envisioned that there are multiple ways in which transaction-related content can be provided to a user device by the resource provider 200. For example, at 416, the resource provider may provide a link to a memory location to the user device 222 within a machine-readable code. In this example, the resource provider 416 may upload the transaction-related content to the memory location. In a second example, at 418, the resource provider 200 may generate a second machine-readable code that includes the transaction-related content and may present the second machine-readable code to the user device 222.

It should be noted that at 414, the resource provider may receive only an indication that the transaction has been completed. In other words, the resource provider 200 may not be provided with any identifying information for the user device 222, making the transaction an anonymous transaction. In some embodiments, a transaction processing network may facilitate anonymous clearance and settlement for the transaction and may remove any identifying information from authorization responses provided to the resource provider 200.

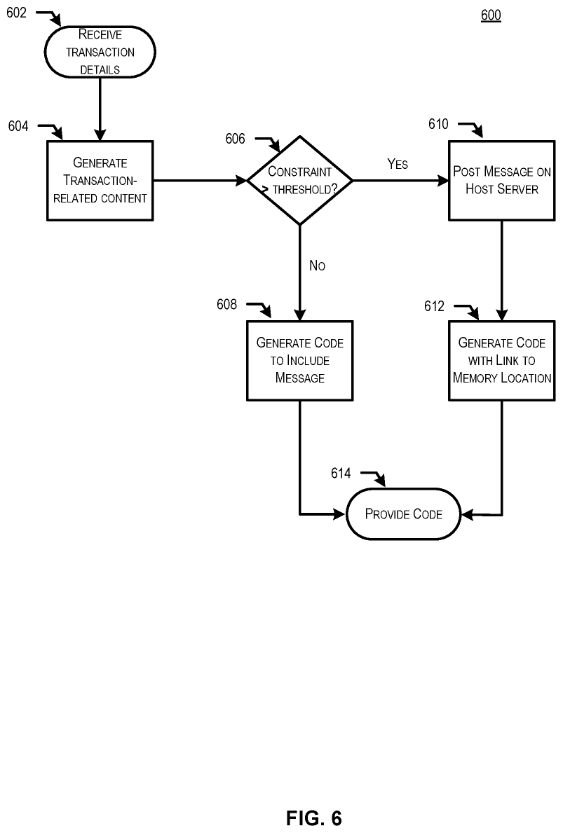

At 420, the user device 222 may obtain the transaction content. In some embodiments, the transaction content may be obtained directly from a machine readable code. In some embodiments, the transaction content may be obtained by referencing content in a link provided via a machine-readable code. The process steps 414, 416, and 418 are described in greater detail below with respect to process 600 depicted in FIG. 6.

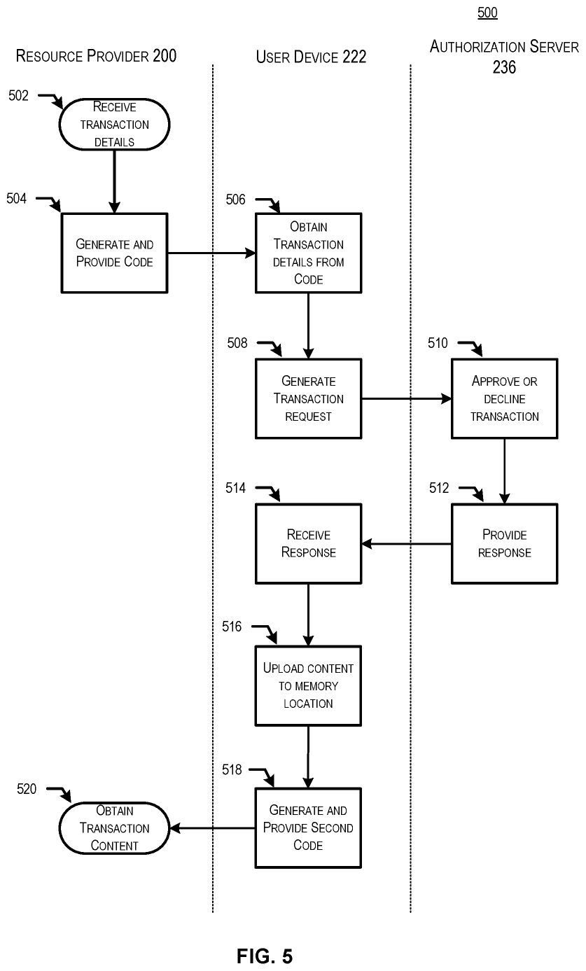

FIG. 5 depicts a block diagram illustrating a second process for conducting a transaction using the system described herein in accordance with at least some embodiments. Similar to the process 400 described above, the process 500 depicted in FIG. 5 focuses on interactions between a resource provider 200, a user device 222, and an authorization server 236 as described with respect to FIG. 2.

In process 500, a resource provider 200 may receive transaction details at 502 associated with a transaction to be completed. In some embodiments, this may involve information obtained regarding selection of one or more items by a user of a user device 222 (e.g., presentation of the one or more items to a POS). In some embodiments, the resource provider 200 may identify a particular product or item to be associated with a transaction independent of any selection by a user. In some embodiments, transaction details may include a serial number, or other unique identifier, associated with a particular item.

At 504, the resource provider 200 may generate a machine-readable code to be associated with a potential transaction. The machine-readable code may be any suitable means of conveying a message that can be interpreted using electronic means (e.g., a barcode).

At 506, the transaction details may be obtained by a user device 222 upon scanning the machine-readable code. In some embodiments, scanning the machine-readable code may cause a transaction application installed on the user device 222 to be activated. For example, the machine-readable code may include instructions to execute the transaction application. In another example, the machine-readable code may include a specific format associated with the transaction application such that the transaction application is caused to be executed in order to interpret the machine-readable code. The transaction details included in the machine-readable code may include any details relevant to a transaction to be completed. In some embodiments, the transaction details may include a link to a memory location.

At 508, the user device 222, via a transaction application installed upon the user device 222, may generate a transaction request using the obtained transaction details and a payment device identifier. For example, the user device 222 may generate an authorization request message for a transaction based on the transaction details provided along with a default or selected payment device identifier. In some embodiments, the transaction request may be generated automatically (e.g., without further user interaction) upon obtaining the transaction details from the machine-readable code. In some embodiments, the user device 222 may request input from the user prior to generating the transaction request. For example, the user device may request authorization to proceed with the transaction or may request selection of a particular payment device from a set of payment devices. In some embodiments, at least a portion of the obtained transaction details may be presented to the user.

At 510, the user device 222 may initiate the transaction by transmitting the generated transaction request to an authorization server 236 associated with the payment device. This may be done by providing the transaction request to a transaction processing network, which may route the transaction request to the appropriate authorization server 236. The authorization server 236 may, upon receiving the transaction request, determine whether to approve or decline the requested transaction. In some embodiments, the determination may be made based on an account balance associated with the payment device. In some embodiments, the authorization server 236 may determine a level of risk associated with the transaction based on one or more factors associated with the transaction and may approve or decline the transaction based on whether the determined level of risk exceeds some threshold risk value. Upon determining whether to approve or decline the transaction, the authorization server 236 may provide an authorization response message at 512.

In some embodiments, upon receiving a response to the authorization request message at 514, the user device 222 may generate a receipt or other transaction-related document. At 516, the generated transaction-related document may be uploaded to a memory location associated with the transaction. In some embodiments, the transaction-related document may be uploaded to a memory location referenced in the link provided to the user device 222 at step 506 above. In some embodiments, the user device 222 may select a new memory location.

Step 518 represents an optional step that may be implemented in accordance with some embodiments. In particular, in embodiments in which the transaction-related document is uploaded to a new memory location by the user device 222, the user device may generate and display a second machine-readable code that includes a link to the second memory location. This machine readable code may then be obtained by the resource provider 200 (e.g., using a reader device).

Once the resource provider 200 has received an indication that the transaction-related document has been uploaded to a memory location, the resource provider 200 may obtain that transaction-related document from the memory location at 520. In some embodiments, this may involve accessing a memory location obtained from the second machine-readable code at step 518. In some embodiments, this may involve periodically checking the memory location referenced in the first machine readable code at 516.

FIG. 6 depicts a flow chart illustrating a process for a resource provider to provide transaction-related content to a user device upon completion of a transaction in accordance with at least some embodiments. The process 600 of FIG. 6 may be performed by at least the resource provider 200 depicted in FIG. 2.

At 602, the process 600 may involve receiving an indication that a transaction has been completed. In some embodiments, the transaction may be conducted as a push transaction initiated on a user device. In some embodiments, the received transaction details may include a unique transaction identifier that can be used to identify one or more items in the conducted transaction based on stored transaction data. In some embodiments, the transaction details may include one or more item identifiers that can be used to identify one or more items included in the transaction.

At 604, the process 600 may involve generating transaction-related content for the conducted transaction. In some embodiments, this may be a receipt or other document indicating a completed status of the transaction. In some embodiments, the transaction-related content may include digital content associated with one or more items of the transaction. The transaction-related content may be formatted as a message (i.e., a string of characters) in a particular format.

In some embodiments, the process 600 may involve determining an appropriate means for providing the transaction-related content to a user device at 606. For example, the resource provider may determine whether one or more constraints associated with the content exceed some threshold value. By way of illustration, the resource provider may determine whether a number of characters in the message is greater than a threshold character number value (e.g., a maximum character limit). The resource provider may then be configured to take separate actions depending on whether the one or more constraints exceed the threshold value as described below.

At 608, upon determining that one or more content constraints (e.g., a message length) does not exceed a threshold, the process 600 may involve generating a machine-readable code to include the entirety of the message for the transaction-related content.

At 610, upon determining that one or more content constraints (e.g., a message length) does exceed a threshold, the process 600 may involve posting the message for the transaction-related content to a memory location. The resource provider may then generate a machine-readable code that includes a link to the memory location at 612. In some embodiments, the link to the memory location may be presented as a uniform resource locator (URL). In some embodiments, the link to the memory location may be shortened using a URL shortener.

A message embedded into a machine-readable code generated in the manner described above may include any suitable transaction-related details. In some embodiments, the message may include a cryptographic key or code that may be used to access transaction-related content.

At 614, the process 600 may involve presenting the generated machine-readable code to a user device. In some embodiments, this may involve displaying the machine-readable code on a display device, from which it may be scanned using a machine-readable code scanner (e.g., a barcode scanner) of the user device. The user device may then access the transaction-related content upon interpreting the machine-readable code.

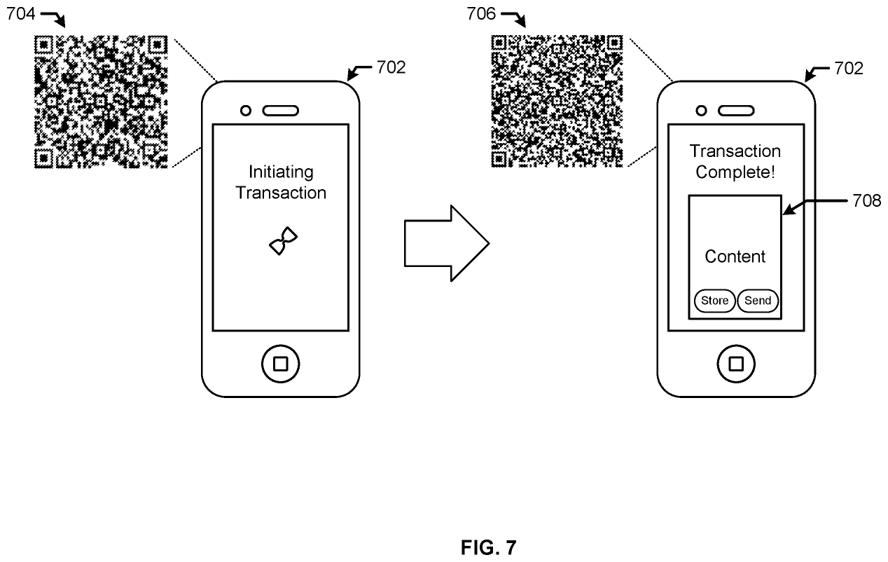

FIG. 7 depicts an illustrative example of a first interaction that may occur in accordance with some embodiments of the disclosure. In particular, FIG. 7 illustrates an embodiment in which a user device 702 is presented with two different machine-readable codes during completion of a transaction. In FIG. 7, the user device 702 is initially presented with a first machine-readable code 704 which includes details to be used in completing the transaction. The user device 702 may be configured to conduct a transaction (e.g., a push transaction) upon obtaining the transaction details included in the first machine-readable code. Upon receiving an indication that the transaction has been completed, a second machine-readable code 706 may be presented to the user device 702. The user device 702 may be further configured to obtain transaction-related content from the second machine-readable code 706.

In some embodiments, each machine-readable code may include a message, which is a string of characters. The message may be formatted in manner that allows for machine parsing and interpretation of the characters within the message. For example, as will be depicted in the examples provided below, the message may be formatted in an extensible markup language (xml) format. It should be noted that any suitable format may be used and the use of an xml format is for illustrative purposes only.

The first machine-readable code 704, when scanned, may be interpreted as including any suitable information needed to conduct the transaction. For example, the first machine-readable code depicted in FIG. 7 may be interpreted by a user device to read:

<Purchase_transaction>

<Transaction_ID>12345678</Transaction_ID>
<Merchant_ID>12345678</Merchant_ID>
<Total_Amount>$132.94</Total_Amount>

</Purchase_transaction>

When scanning the first machine-readable code 704, the user device 702 may be caused to generate a transaction request that includes at least a portion of the above information as well as an identifier for a payment device to be used in completing the transaction. The user device 702 may then transmit the generated transaction request to a transaction processing network to be routed to an authorization server associated with the payment device.

Subsequent to the generation and transmission of the transaction request in the depicted example, the resource provider may receive an indication of completion of the transaction. Upon receiving the indication, the resource provider may generate a second machine-readable code 706 that includes transaction-related content to be provided to the user device 702.

The second machine-readable code 706, when scanned, may be interpreted as including information related to completion of the transaction (e.g., transaction-related content). For example, the second machine-readable code depicted in FIG. 7 would be interpreted as:

<Receipt>

<Merchant>Acme Retail</Merchant>
<Items>

<item_1>

<name>”snapmaster_camera”</name>
<price>$110.86</price>

</item_1>
<item_2>

<name>”camera_film”</name>
<price>$9.99</price>

</item_2>

</Items>
<Subtotal>$120.85</Subtotal>
<Sales_Tax>$12.09</Sales_Tax>
<Total_Amount>$132.94</Total_Amount>

</Receipt>

When scanning the second machine-readable code 706, the user device 702 may be caused to obtain the transaction-related content from the machine-readable code. In some embodiments, this may involve parsing the information included within the machine-readable code 706 and translating that information into transaction-related content. In some embodiments, this may involve obtaining a link to a reference location included within the machine-readable code 706 and accessing the transaction-related content 708 located in the memory location. In at least some of these embodiments, the user device 702 may periodically attempt to access the memory location until the transaction-related content 708 becomes available (i.e., is placed in the memory location by the resource provider). It should be noted that though the example machine-readable code 706 depicted does not include a link to a memory location, some embodiments of machine-readable code 706 may include such a link as described elsewhere.

It should be noted that, in some embodiments, the speed of the system may be such that the machine-readable code 706 may be generated within a fraction of a second of the user device 702 obtaining data from machine-readable code 704. It is envisioned that in at least some of these embodiments, the second machine-readable code 706 may be presented to the user device 702 before the user has moved the user device 702 out of the position that it was placed in to read machine readable code 704. In these embodiments, the switch from machine-readable code 704 to machine-readable code 706 may be automatic and imperceptible to the user, such that the user is able to complete the transaction with a “single” scan of a QR code.

In some embodiments, a user of the user device 702 may be presented with an option to store the transaction-related content locally to the memory of the user device or to send the transaction-related content to another entity. In some embodiments, upon selection of an option to send the transaction-related content to another device or entity, the user device 702 may transmit a link to a memory location provided in the machine-readable code 706.

FIG. 8 depicts an illustrative example of a second interaction that may occur in accordance with some embodiments of the disclosure. In particular, FIG. 8 illustrates an embodiment in which a user device 802 is presented with a single machine-readable code 804 during completion of a transaction. In FIG. 8, the user device 802 is may be configured to conduct a transaction (e.g., a push transaction) upon obtaining transaction details included in the machine-readable code 804. Upon receiving an indication that the transaction has been completed, a resource provider for the transaction may update a content located at a memory location provided to the user device 802 within the machine-readable code 804. The user device 802 may be further configured to obtain transaction-related content from the memory location.

The machine-readable code 804, when scanned, may be interpreted as including any suitable information needed to conduct the transaction. For example, the machine-readable code depicted in FIG. 8 may be interpreted by a user device to read:

<Purchase_transaction>

<Merchant_ID>12345678</Merchant_ID>
<Name>”snapmaster_camera”</Name>
<Price>$110.86</Price>
<Serial_Num>12345678</ Serial_Num>
<Link>memorylocation.com/ref_loc.12345678</Link>

</Purchase_transaction>

When scanning the second machine-readable code 706, the user device 702 may be caused to conduct a transaction using the information obtained from the machine-readable code.

As illustrated above, the machine-readable code 804 may include a reference link to a memory location (e.g., memorylocation.com/ref_loc.12345678 above). In some embodiments, this memory location may be assigned to a particular item 806 or product. For example, the memory location may be tied to a serial number or other unique identifier for an item 806 involved in the transaction. In another example, a resource provider may print out machine-readable codes that each include a unique identifier regardless of any serial number or other item-specific identifier. Upon detecting that a transaction has been completed, a resource provider may receive an indication of an identifier associated with the transaction and may update the memory location associated with that identifier to include transaction-related content 808. The user device 802 may then retrieve the transaction-related content 808 from the memory location. In some embodiments, the user device 802, upon submission of a transaction request for the transaction, may periodically query the memory location to detect the uploaded content and may retrieve the content as soon as it detects that the content has been added.

In some embodiments, the transaction-related content may include details of the transaction to be displayed upon the user device. For example, the user device may be caused to display an image of a purchased item so that a resource provider employee checking receipts may easily determine that the conducted transaction relates to the selected item. In another example, the user device may be caused to display a time at which the transaction was completed and/or an amount for which the transaction was conducted.

By way of illustrative example, consider a scenario in which a user enters a physical retail location associated with a merchant resource provider. In this illustrative example, the resource provider may have affixed QR codes to each of the products that the merchant offers for sale at the retail location. Each QR code may include a link to a memory location which is unique to the item to which the QR code is affixed. A user entering the store may scan, using his or her user device, a QR code on an item that he or she wishes to purchase, which would cause the user device to initiate a push purchase transaction to obtain rights to that item. The resource provider, upon receiving an indication that the push purchase transaction has been approved, may generate a receipt for the item and upload that receipt to the memory location. The user's user device would then retrieve the receipt for the item from the memory location. It should be noted that the merchant is provided no payment device information (or any other identifying information) that can be used to defraud the user during this transaction, while the user is able to quickly, and anonymously, obtain the items that he or she desires without the need to “check out.”

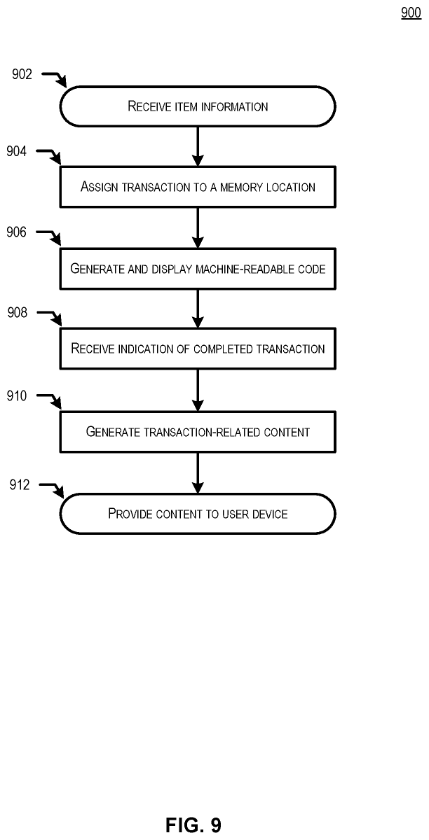

FIG. 9 depicts a flow diagram illustrating an example process for providing transaction-related content to a user device in accordance with at least some embodiments. Process 900 may be performed by a resource provider such as the resource provider 200 described with respect to FIG. 2 above.

Process 900 may begin at 902, when item information is received for a transaction to be conducted. In some embodiments, the item information may include a list of one or more items for which a transaction is to be conducted. In some embodiments, the item information may include a serial number for a specific instance of an item.

In some embodiments, the process may involve assigning the transaction to a memory location at 904. The process may also involve generating a reference link that refers to that memory location. In some embodiments, the reference link may reference a location in memory which is associated with (e.g., located on) a remote server. In some embodiments, the location in memory may be associated with a serial number for a specific instance of an item.

At 906, the process may involve generating and displaying a machine-readable code. The machine-readable code may be any suitable symbol or image capable of being interpreted by an electronic device. In some embodiments, the machine-readable code may be a quick response (QR) code. In some embodiments, the machine-readable code includes the reference link.

At 908, the process may involve receiving an indication of the transaction having been completed. In some embodiments, the transaction may be completed via a push transaction processing system. In order to maintain anonymity of the user device (and the user), the indication of completion of the transaction may be devoid of identifying information for the user device. For example, the transaction may be completed using a payment device associated with the user device. In this example, the resource provider computer may not be provided with any indication of the payment device. In some embodiments, the indication of the transaction having been completed may be an authorization response message. Identifying information such as payment device identifiers and phone numbers may be removed from an authorization response message by a transaction processing network prior to the authorization response message being provided to the resource provider.

At 910, the process may involve generating transaction-related content for the completed transaction. In some embodiments, the transaction-related content is a receipt for the transaction. In some embodiments, the transaction-related content includes documentation relating to at least one of the one or more items, such as a user manual, a warranty application, a deed, or bonus content for an item.

At 912, the process may involve providing the transaction-related content to a user device. In some embodiments, this may involve generating, by the resource provider computer based at least in part on the indication of completion of the transaction, a second machine-readable code which includes the reference link. In some embodiments, the second machine-readable code is presented to the user device within a fraction of a second of the machine-readable code being scanned by a user device. This enables the user to complete a transaction and obtain the transaction-related content with a single motion (in which the user device scans both machine-readable codes). In some embodiments, providing the user device with access to the transaction-related content may involve generating a second machine-readable code that includes the transaction-related content (as opposed to a reference link). In some cases, the second machine-readable code that includes the transaction-related content is generated only if a character length of the transaction-related content is below a threshold value. In other cases, a third machine-readable code that includes a link to a memory location is generated if a character length of the transaction-related content exceeds the threshold value.

Embodiments of the disclosure provide for a number of advantages over conventional systems. For example, the system described herein enables push transactions to be conducted by a user while providing transaction-related content to the user and maintaining anonymity during the transaction. While other systems may offer the ability to obtain transaction-related content, these systems conventionally require that a resource provider be provided some means of contacting a user (e.g., a payment device identifier, a phone number, etc.), which can then be used to identify that user. Unscrupulous resource providers (or unscrupulous employees of resource providers) may then use that identifying information to defraud a user. This is prevented in the current system by enabling complete anonymity for the user while still enabling the user to conduct the transaction while gaining any benefit for the transaction.

It should be understood that any of the embodiments of the present disclosure can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the disclosure will become apparent to those skilled in the art upon review of the disclosure. The scope of the disclosure should, therefore, be determined not with reference to the above description, but instead should be determined with reference to the pending claims along with their full scope or equivalents.

One or more features from any embodiment may be combined with one or more features of any other embodiment without departing from the scope of the disclosure.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, at a resource provider computer, an indication of one or more items for which a transaction is to be conducted;
assigning, by the resource provider computer to the transaction, a reference link, the reference link comprising a reference to a location stored in memory;
generating, by the resource provider computer based at least in part on details of the transaction, a machine-readable code;
displaying, by the resource provider computer, the machine-readable code, the machine-readable code capable of being scanned by a user device;
upon receiving an indication of completion of the transaction at the resource provider computer, generating a transaction-related content; and
storing, by the resource provider computer at the memory location, the generated transaction-related content, wherein the transaction-related content may be accessed by the user device via the reference link.

2. The method of claim 1, wherein the transaction is completed via a push transaction processing system.

3. The method of claim 1, wherein the indication of completion of the transaction is devoid of identifying information for the user device.

4. The method of claim 1, wherein the machine-readable code is a quick response (QR) code.

5. The method of claim 1, wherein the machine-readable code includes the reference link.

6. The method of claim 1, further comprising generating, by the resource provider computer based at least in part on the indication of completion of the transaction, a second machine-readable code, wherein the second machine-readable code includes the reference link.

7. The method of claim 6, wherein the second machine-readable code is presented to the user device within a fraction of a second of the machine-readable code being scanned by a user device.

8. The method of claim 1, wherein the location stored in memory is associated with a remote server.

9. The method of claim 1, wherein the item information comprises a serial number for a specific instance of an item of the one or more items.

10. The method of claim 9, wherein the location stored in memory is associated with the serial number for the specific instance of the item.

11. A resource provider computer comprising:
A display device;
a processor; and
a memory including instructions that, when executed with the processor, cause the resource provider computer to, at least:
receive an indication of one or more items for which a transaction is to be conducted;
generate, based at least in part on details of the transaction, a machine-readable code capable of being scanned by a user device;
display the machine-readable code via the display device;
upon receiving an indication of completion of the transaction at the resource provider computer, generate a transaction-related content; and
provide the user device with access to the transaction-related content.

12. The resource provider computer of claim 11, wherein providing the user device with access to the transaction-related content comprises generating a second machine-readable code that includes the transaction-related content.

13. The resource provider computer of claim 12, wherein the second machine-readable code that includes the transaction-related content is generated if a character length of the transaction-related content is below a threshold value.

14. The resource provider computer of claim 13, wherein a third machine-readable code that includes a link to a memory location is generated if a character length of the transaction-related content exceeds the threshold value, wherein the transaction-related content is stored at the memory location.

15. The resource provider computer of claim 11, wherein the transaction is completed using a payment device associated with the user device.

16. The resource provider computer of claim 15, wherein the resource provider computer is not provided with any indication of the payment device.

17. The resource provider computer of claim 11, wherein any identifying information is removed from the indication of completion of the transaction by a transaction processing network.

18. The resource provider computer of claim 11, wherein the transaction-related content comprises a receipt for the transaction.

19. The resource provider computer of claim 11, wherein the transaction-related content comprises documentation relating to at least one of the one or more items.

20. The resource provider computer of claim 19, wherein the transaction-related content comprises at least one of a user manual, a warranty application, a deed, or bonus content associated with the at least one of the one or more items.
